(19) United States
(12) Patent Application Publication
(10) Pub. No.: US 2019/0362884 A1
(43) Pub. Date: Nov. 28, 2019

(54) HIGH FREQUENCY INDUCTOR

(71) Applicant: SAMSUNG ELECTRO-MECHANICS CO., LTD., Suwon-si (KR)

(72) Inventors: Hyeok Jung KWON, Suwon-si (KR); Yong Sun PARK, Suwon-si (KR); Sung Jin PARK, Suwon-si (KR); Jong Suk JUNG, Suwon-si (KR)

(21) Appl. No.: 16/161,982

(22) Filed: Oct. 16, 2018

(30) Foreign Application Priority Data
May 25, 2018 (KR) 10-2018-0059829

(51) Int. Cl. H01F 27/32; H01F 27/29; H01F 17/00

(52) U.S. Cl. CPC H01F 27/32; H01F 17/0013; H01F 27/292

(57) ABSTRACT

An inductor includes a body including a stacked plurality of insulating layers, and a plurality of coil patterns arranged on the insulating layers; and first and second external electrodes disposed on a first surface of the body. The plurality of coil patterns are connected to each other through coil connection portions and form a coil having first and second ends connected to the first and second external electrodes through first and second coil lead-out portions, respectively, and a shortest distance L1 between the coil patterns and a second surface of the body opposing the first surface is shorter than a shortest distance L2 between the coil patterns and the first surface of the body.

### CROSS-REFERENCE TO RELATED APPLICATION(S)

This application claims the benefit of priority to Korean Patent Application No. 10-2018-0059829 filed on May 25, 2018 in the Korean Intellectual Property Office, the disclosure of which is incorporated herein by reference in its entirety.

### BACKGROUND

### 1. Field

The present disclosure relates to a high frequency inductor.

### 2. Description of Related Art

Recently, smartphones have been implemented with the ability to use many frequency bands due to the application of multiband long term evolution (LTE). As a result, high frequency inductors are largely used as impedance matching circuits in signal transmission and reception RF transmission and reception systems. High frequency inductors are required to be smaller in size and higher in capacity. Additionally, high frequency inductors are required to have high self-resonant frequency (SRF) in a high frequency band and low resistivity to use a signal having a high frequency of 100 MHz or more. Also, high frequency inductors are required to have high Q characteristics so as to reduce the loss at the used frequency.

In order to have such a high Q characteristics, the characteristics of a material constituting an inductor body have the greatest influence. However, even if the same material is used, since a Q value may vary according to the shape of an inductor coil, there is a need for a method of optimizing the shape of the inductor coil to have a higher Q characteristic.

### SUMMARY

An aspect of the present disclosure may provide an inductor having a high Q characteristic.

According to an aspect of the present disclosure, an inductor may include a body in which a plurality of insulating layers on which a plurality of coil patterns are arranged are stacked; and first and second external electrodes disposed on a first surface of the body, wherein the plurality of coil patterns are connected to each other through a coil connection portion and form a coil having both ends connected to the first and second external electrodes through a coil lead-out portion, and wherein a shortest distance L1 between the coil patterns and a second surface of the body opposing the first surface of the body is shorter than a shortest distance L2 between the coil patterns and the first surface of the body.

According to another aspect of the present disclosure, an inductor may include a plurality of insulating layers on which a coil pattern is disposed; and an external electrode disposed on a first surface of the insulating layers and connected to the coil pattern, and wherein a shortest distance between the coil pattern and a second surface of the insulating layers opposing the first surface is shorter than a shortest distance between the coil pattern and the external electrode.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a projected perspective view schematically illustrating an inductor according to an exemplary embodiment in the present disclosure;

FIG. 2 is a front view of the inductor shown in FIG. 1;

FIG. 3 is a plan view of the inductor shown in FIG. 1; and

FIG. 4 is a graph showing a Q characteristic of an inductor shown in Table 1.

### DETAILED DESCRIPTION

Hereinafter, exemplary embodiments in the present disclosure will now be described in detail with reference to the accompanying drawings.

Hereinafter, W, L, and T in the drawings may be defined as a first direction, a second direction, and a third direction, respectively.

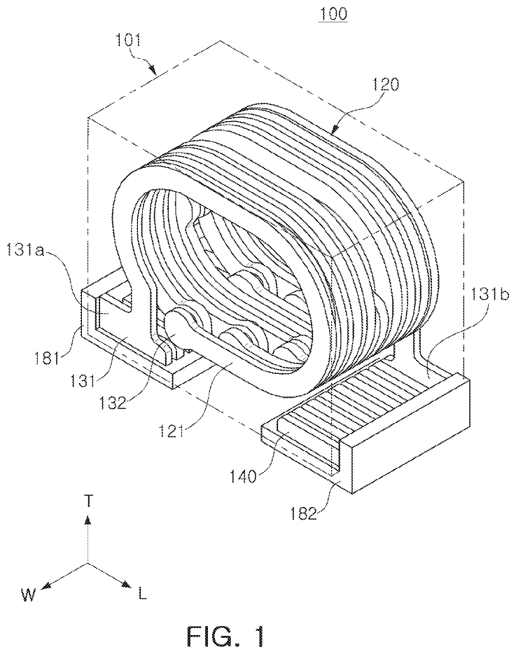

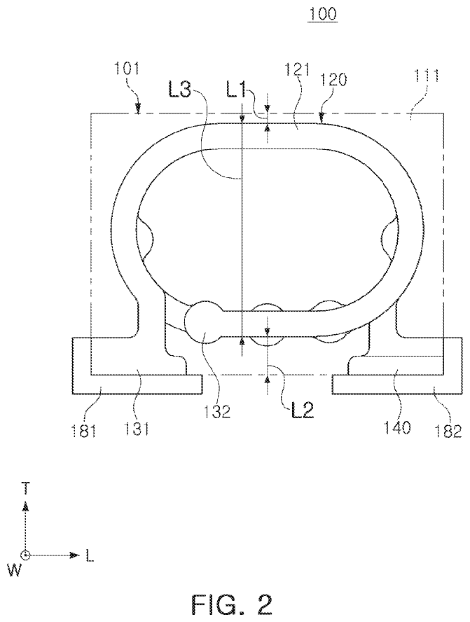

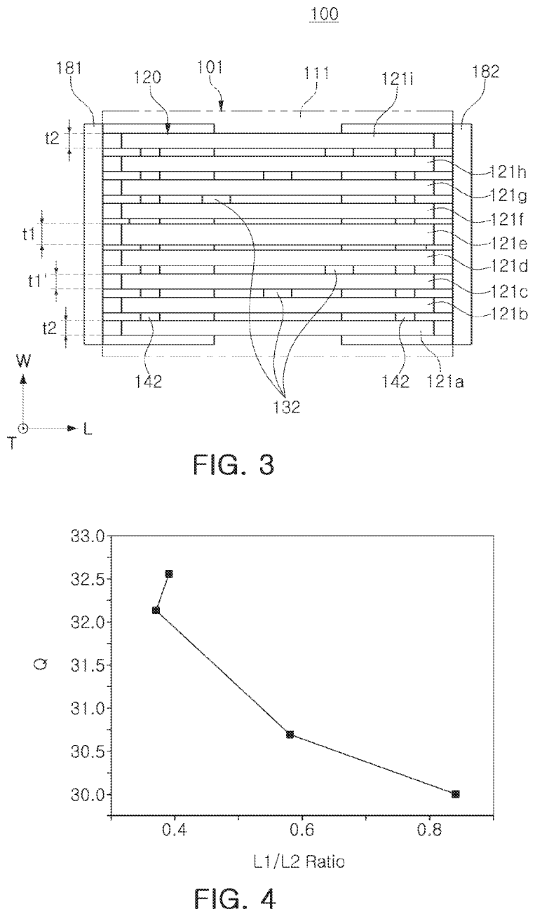

FIG. 1 is a projected perspective view schematically illustrating an inductor 100 according to an exemplary embodiment in the present disclosure. FIG. 2 is a front view of the inductor 100 shown in FIG. 1. FIG. 3 is a plan view of the inductor 100 shown in FIG. 1.

A structure of the inductor 100 according to an exemplary embodiment in the present disclosure will be described with reference to FIGS. 1 through 3. The inductor 100 according to the present embodiment is a thin film high frequency inductor and is configured to have a thickness of 0.3 mm or less.

A body 101 of the inductor 100 may be formed by stacking a plurality of insulating layers 111 in a first direction perpendicular to a mounting surface.

The insulating layer 111 may be a magnetic layer or a dielectric layer.

When the insulating layer 111 is the dielectric layer, the insulating layer 111 may include BaTiO₃ (barium titanate) based ceramic powder or the like. In this case, the BaTiO₃ based ceramic powder may be, for example, (Ba₁₋ₓCaₓ)TiO₃, Ba(Ti_{1-y}Ca_{y})O₃, (Ba₁₋ₓCaₓ) (Ti_{1-y}Zr_{y})O₃ or Ba(Ti_{1-y}Zr_{y})O₃ in which Ca (calcium), Zr (zirconium), etc. are partially employed in BaTiO₃, but the present disclosure is not limited thereto.

When the insulating layer 111 is the magnetic layer, the insulating layer 111 may select a suitable material from materials that may be used as the body 101 of the inductor 100, for example, resin, ceramic, ferrite, etc. In the present embodiment, the magnetic layer may use a photosensitive insulating material, thereby enabling the implementation of a fine pattern through a photolithography process. That is, by forming the magnetic layer with the photosensitive insulating material, a coil pattern 121, a coil lead-out portion 131 and a coil connection portion 132 may be finely formed, thereby contributing to the miniaturization and function improvement of the inductor 100. To this end, the magnetic layer may include, for example, a photosensitive organic material or a photosensitive resin. In addition, the magnetic layer may further include an inorganic component such as SiO₂/Al₂O₃/BaSO₄/Talc, etc. as a filler component.

First and second external electrodes 181 and 182 may be disposed outside the body 101.

For example, the first and second outer electrodes 181 and 182 may be disposed on a first surface of the body 101. The first surface refers to a surface facing a printed circuit board (PCB) when the inductor 100 is mounted on the PCB.

The external electrodes 181 and 182 serve to electrically connect the inductor 100 to the PCB when the inductor 100 is mounted on the PCB. The external electrodes 181 and 182 are spaced apart from each other on an edge of the first surface of the body 101.

Also, the external electrodes 181 and 182 of the present embodiment extend from the first surface of the body 101 and are also formed on the side surface of the body 101. In this case, an area of the external electrodes 181 and 182 disposed on the side surface of the body 101 may be less than half an area of the side surface. However, the present disclosure is not limited thereto.

The external electrodes 181 and 182 may include, for example, a conductive resin layer and a conductive layer formed on the conductive resin layer, but are not limited thereto. The conductive resin layer may include one or more conductive metals selected from the group consisting of copper (Cu), nickel (Ni), and silver (Ag) and a thermosetting resin. The conductive layer may include one or more materials selected from the group consisting of nickel (Ni), copper (Cu), and tin (Sn). For example, a nickel (Ni) layer and a tin (Sn) layer may be sequentially formed.

Referring to FIGS. 1 through 3, the coil pattern 121 may be formed on the insulating layer 111.

The coil pattern 121 may be electrically connected to the adjacent coil pattern 121 by the coil connection portion 132. That is, the helical coil patterns 121 are connected by the coil connection portion 132 to form a coil 120. The coil connection portion 132 may have a line width larger than that of the coil pattern 121 to improve the connection between the coil patterns 121 and may include a conductive via passing through the insulating layer 111.

First and second ends of the coil 120 are connected to the first and second external electrodes 181 and 182 by coil lead-out portions 131, respectively. The coil lead-out portion 131 may include first and second coil lead-out portions 131a and 131b, and the first and second coil lead-out portions may be respectively exposed at first and second ends of the body 101 in a longitudinal direction to be exposed to a bottom surface that is a substrate mounting surface. Accordingly, the coil lead-out portion 131 may have an L-shaped cross section in the length-thickness direction of the body 101.

Referring to FIGS. 2 and 3, a dummy electrode 140 may be formed at a position corresponding to the external electrodes 181 and 182 in the insulating layer 111. The dummy electrode 140 may serve to improve the adhesion between the external electrodes 181 and 182 and the body 101 or may serve as a bridge when the external electrodes 181 and 182 are formed by plating.

The dummy electrode 140 and the coil lead-out portion 131 may also be connected to each other by a via electrode.

As materials of the coil pattern 121, the coil lead-out portion 131 and the coil connection portion 132, conductive materials having excellent conductivity such as copper, aluminum (Al), silver (Ag), tin (Sn), gold (Au), nickel (Ni), lead (Pb) or alloys thereof. The coil pattern 121, the coil lead-out portion 131, and the coil connection portion 132 may be formed by a plating method or a printing method, but are not limited thereto.

The inductor 100 according to an exemplary embodiment in the present disclosure is manufactured by forming the coil pattern 121, the coil lead-out portion 131 or the coil connection portion 132 on the insulating layer 111 and then stacking the insulating layer 111 on the mounting surface in the first direction horizontal to the mounting surface as shown in FIG. 2, and thus the inductor 100 may be easily manufactured. Also, since the coil pattern 121 is disposed perpendicularly to the mounting surface, the influence of a magnetic flux by the mounting substrate may be minimized.

Referring to FIGS. 2 and 3, the coil 120 of the inductor 100 according to an exemplary embodiment in the present disclosure forms a coil track having one or more coil turn number by overlapping the coil patterns 121 when projected in the first direction.

Specifically, the first external electrode 181 and the first coil pattern 121a are connected by the coil lead-out portion 131, and then first through ninth coil patterns 121a through 121i are sequentially connected by the coil connection portion 132. Finally, the ninth coil pattern 121i is connected to the second external electrode 182 by the coil lead-out portion 131 to form the coil 120.

The inductor 100 according to the present embodiment configured above has the coil pattern 121 that is not disposed at the central portion of the body 101 but is inclined upward.

Specifically, as shown in FIG. 2, a shortest distance L1 between the coil pattern 121 and a second surface of the body 101 opposing the first surface is shorter than a shortest distance L2 between the coil pattern 121 and the first surface of the body 101. According to the above configuration, the coil pattern 121 is disposed as far as possible from the first and second outer electrodes 181 and 182 and thus, the parasitic capacitance generated between the coil pattern 121 and the first and second external electrodes 181 and 182 may be minimized.

When L1 is extremely short, the coil pattern 121 may be disposed very close to the second surface of the body 101 and thus, projection of the coil pattern 121 may occur on the second surface of the body 101.

In this case, during a process of inspecting the outer shape of the completely manufactured inductor 100, the coil pattern 121 may be recognized as a defective product exposed to the outside of the insulating layer 111 and processed as the defective product.

Therefore, in order to solve the above problem, L1/L2 is formed to be 0.1 or more in the present embodiment.

When L1 is less than 5 μm, the projection of the coil pattern 121 may occur on the second surface of the body 101 as described above. Therefore, in the present embodiment, L1 is formed to be 5 μm or more.

However, the present disclosure is not limited thereto. L1 may be changed according to the thickness of the inductor 100, the material of the insulating layer 111, the size of the coil pattern 121, and the like.

Meanwhile, as L1/L2 becomes larger, the coil pattern 121 is disposed closer to the external electrodes 181 and 182. Therefore, as L1/L2 approaches 1, the parasitic capacitance between the coil pattern 121 and the external electrodes 181 and 182 increases, which lowers the Q characteristic of the inductor 100.

Table 1 below shows the measurement of the Q characteristic of an inductor according to L1/L2. FIG. 4 is a graph showing the Q characteristic of the inductor shown in Table 1.

Referring to Table 1 and FIG. 4, in Embodiment 1 in which L1/L2 is 0.84, the Q characteristic of the inductor is 30.01 and in Embodiment 4 in which L1/L2 is 0.39, the Q characteristic of the inductor is 32.56.

Therefore, it may be seen that the Q characteristic of Embodiment 4 in which L1/L2 is relatively low is about 8.5% higher than that of Embodiment 1.

TABLE 1

| | | | | Q |
|---|---|---|---|---|
| Classification | L1 | L2 | L1/L2 | (2.4 Ghz) |
| Embodiment 1 | 24.59 | 29.43 | 0.84 | 30.01 |
| Embodiment 2 | 19.82 | 34.24 | 0.58 | 30.7 |
| Embodiment 3 | 15.02 | 40.42 | 0.37 | 32.14 |
| Embodiment 4 | 15.62 | 40.41 | 0.39 | 32.56 |

The inductor according to the present embodiment may define the maximum value of L1/L2 to be 0.6. Referring to FIG. 4, in a section where L1/L2 is greater than 0.6, the variation of the Q characteristic is relatively small compared to other sections. Therefore, in the present embodiment, L1/L2 is configured to be 0.6 or less.

Thus, the inductor according to the present embodiment satisfies the following Formula 1 in the ratio of L1 to L2.

0.1≤L1/L2≤0.6 (Formula 1)

Meanwhile, as shown in FIG. 1, the external electrodes 181 and 182 may extend from the first surface of the body 101 and may be formed on the side surface of the body 101.

In this case, the parasitic capacitance may also be generated between the coil pattern 121 and the external electrodes 181 and 182 formed on the side surface of the body 101.

Therefore, in order to minimize the parasitic capacitance between the coil pattern 121 and the external electrodes 181 and 182 formed on the side surface of the body 101, the shortest distance between the coil pattern 121 and the external electrodes 181 and 182 is defined to be equal to or greater than L2.

An inductor according to the present embodiment configured as described above increases a spaced distance between a coil pattern and external electrodes to minimize the parasitic capacitance generated between the coil pattern and the external electrodes, thereby providing a high Q characteristic.

As set forth above, according to the exemplary embodiment in the present disclosure, an inductor may increase a spaced distance between a coil pattern and external electrodes to minimize the parasitic capacitance generated between the coil pattern and the external electrodes, thereby providing a high Q characteristic.

While exemplary embodiments have been shown and described above, it will be apparent to those skilled in the art that modifications and variations could be made without departing from the scope in the present invention as defined by the appended claims.

What is claimed is:

1. An inductor comprising:
a body including a stacked plurality of insulating layers, and a plurality of coil patterns arranged on the insulating layers; and
first and second external electrodes disposed on a first surface of the body,
wherein the plurality of coil patterns are connected to each other through coil connection portions and form a coil having first and second ends connected to the first and second external electrodes through first and second coil lead-out portions, respectively, and
wherein a shortest distance L1 between the coil patterns and a second surface of the body opposing the first surface of the body is shorter than a shortest distance L2 between the coil patterns and the first surface of the body.

2. The inductor of claim 1, wherein 0.1≤L1/L2≤0.6.

3. The inductor of claim 2, wherein a thickness of the body is less than or equal to 0.3 mm.

4. The inductor of claim 1, wherein the first and second external electrodes are disposed on the first surface of the body.

5. The inductor of claim 4, wherein a shortest distance between the coil patterns and the first and second external electrodes is configured to be equal to or greater than L2.

6. The inductor of claim 5, wherein the first and second external electrodes each extend to a side surface of the body.

7. The inductor of claim 1, wherein the plurality of coil patterns are stacked to be perpendicular with respect to a substrate mounting surface.

8. The inductor of claim 1, wherein L1 is greater than or equal to 5 μm.

9. An inductor comprising:
a plurality of insulating layers on which a coil pattern is disposed; and
an external electrode disposed on a first surface of the insulating layers and connected to the coil pattern,
wherein a shortest distance between the coil pattern and a second surface of the insulating layers opposing the first surface is shorter than a shortest distance between the coil pattern and the external electrode.
